(19) United States
(12) Patent Application Publication
(10) Pub. No.: US 2016/0351161 A1
(43) Pub. Date: Dec. 1, 2016

(54) IMAGE DISPLAY SYSTEM AND IMAGE DATA CAPTURE DEVICE

(71) Applicant: ASUSTeK COMPUTER INC., Taipei City (TW)

(72) Inventor: Yung-Yu Chiang, Taipei City (TW)

(21) Appl. No.: 15/162,633

(22) Filed: May 24, 2016

(30) Foreign Application Priority Data
May 25, 2015 (CN) 201510269933.5

(51) Int. Cl. G09G 5/00; H04N 7/01; H04N 7/015; G06T 3/40

(52) U.S. Cl. CPC G09G 5/005; G09G 5/006; G06T 3/4092; H04N 7/0122; H04N 7/015; G09G 2340/02; G09G 2340/0407; G09G 2340/0442

(57) ABSTRACT

An image display system and an image data capture device are disclosed. The image data capture device includes a connector, a controller, and a storage device. The connector is connected to an image data transfer path of a display and receives the image data transferred on the image data transfer path directly. The controller encodes or decodes the image data and generates processed image data. The storage device stores the processed image data.

### CROSS-REFERENCE TO RELATED APPLICATION

This application claims the priority benefit of China application serial No. 201510269933.5, filed on May 25, 2015. The entirety of the above-mentioned patent application is hereby incorporated by reference herein and made a part of specification.

### BACKGROUND OF THE INVENTION

### Field of the Invention

The invention relates to an image data capture device and, more particularly, to an image data capture device capturing original image data in an image display system.

### Description of the Related Art

Along with the development of the electronic technology, electronic devices become important in daily life. In a display technology field, people require a high quality and convenient image display system to have a good display effect.

For users' convenience, capturing screenshots are popular in any occasion anytime. However, the revolution of screenshot data is low. Furthermore, it is inconvenient due to complicated operations of some of available applications. In addition, it is also inconvenient that the execution of the applications need a micro-processer of a host connected to the display.

### BRIEF SUMMARY OF THE INVENTION

According to a first aspect of the present disclosure, an image data capture device, comprises: a connector connected to an image data transfer path of a display and receiving image data transferred on the image data transfer path; a controller coupled with the connector, encoding and decoding the image data to generate a processed image data; and a storage device coupled with the controller, for storing the processed image data.

According to a second aspect of the present disclosure, an image display system, comprises: a display having a data source connector, for receiving image data; and an image data capture device, including: a connector connected to the data source connector and receiving the image data; a controller coupled with the connector, encoding and decoding the image data to generate a processed image data; and a storage device coupled with the controller and storing the processed image data.

The image data capture device provided herein directly captures and obtains the original image data received by the display, and thus the original image data is stored in the image data capture device. The original image data can be repeatedly played in any other displays and shared with others via Internet.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an image data capture device in an embodiment;

FIG. 2 is a schematic diagram showing an image display system in an embodiment;

FIG. 3 is a schematic diagram showing an image display system in an embodiment; and

FIG. 4 is a schematic diagram showing an image data capture device in an embodiment.

### DETAILED DESCRIPTION OF THE EMBODIMENTS

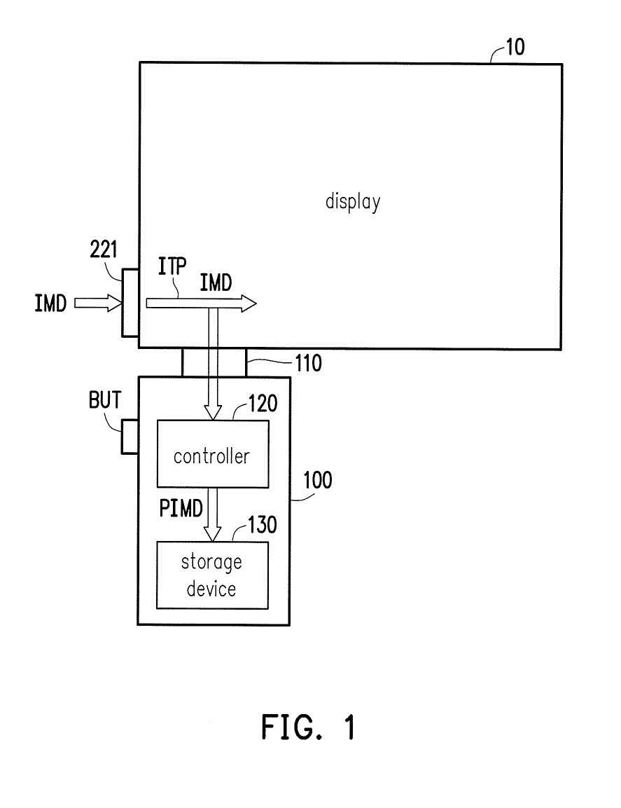

Please refer to FIG. 1. FIG. 1 is a schematic diagram showing an image data capture device in an embodiment. An image data capture device 100 includes a connector 110, a controller 120, and a storage device 130. The connector 110 is connected to an image data transfer path of a display 10 and receives the image data IMD transferred on the image data transfer path directly. The controller 120 is coupled to the connector 110 and receives the image data IMD via the connector 110. The controller 120 encodes and decodes the image data IMD to generate processed image data PIMD. In an embodiment, the controller 120 is a codec chip. The controller 120 encodes the image data IMD and then transfers the processed image data PIMD (after encoded) to the storage device 130.

The storage device 130 coupled to the controller 120 stores the processed image data PIMD. In the embodiment, the storage device 130 is a memory in any type. In other embodiments, the storage device 130 is data storage medium, such as an optical disk or a hard disk.

In an embodiment, the image data IMD received by the image data capture device 100 is original image data received by the display 10. In other words, the image data capture device 100 captures the image data IMD before an image scaler of the display 10 is executed, that is, the image data IMD is not scaled. In an embodiment, the image data IMD is in a three primary colors (Red R, Green G, Blue B) format and which comprises High-Bandwidth Digital Content Protection (HDCP) format.

In the embodiment, the connector 110 is any connector capable of transferring image data, such as HDMI, VGA or DVI, which is not limited herein.

The display 10 connected to the image data capture device 100 is a television, a monitor of a computer, or a display of a mobile phone, which is not limited herein.

The image data capture device 100 further includes a switching unit BUT. In an embodiment, the switching unit BUT is disposed on the casing of the image data capture device 100. The function of capturing an image is triggered by pressing the switching unit BUT.

In operation, the image data capture device 100 is connected to the display 10 via the connector 110. During a period that the display 10 receives the image data IMD and displays the images, the switching unit BUT allows to be pressed to capture the image data. During a period of capturing the image data, the controller 120 continuously encodes the received image data IMD, and the controller 120 stores the processed image data PIMD in the storage device 130. During the period of capturing the image data, all image data corresponding to the images displayed on the display 10 is captured and stored in the storage device 130. The operation of capturing the image data of the image data capture device 100 stops when the switching unit BUT is pressed again.

In an embodiment, the image data capture device 100 is detached from the display 10 after the image data capture operation stops. In an embodiment, the stored image data is shared when the image data capture device 100 is connected to an external display (not shown in the figures) via the connector 110. The controller 120 reads and decodes the processed image data stored in the storage device 130 to generate a decoded image data. After decoding, the decoded image data is transferred to the external display via the connector 110, and the external display displays the images. In an embodiment, the image data is able to be uploaded to be shared on Internet.

In an embodiment, the image data capture device 100 provides the decoded image data with multiple display formats, such as 720p or 1080p, MPEG2 (Moving Picture Experts Group), MPEG3, or MPEG4, to the external display.

As stated above, an image data with high quality is obtained via an image capture interface of the image data capture device 100, and the captured image data can be easily and conveniently shared.

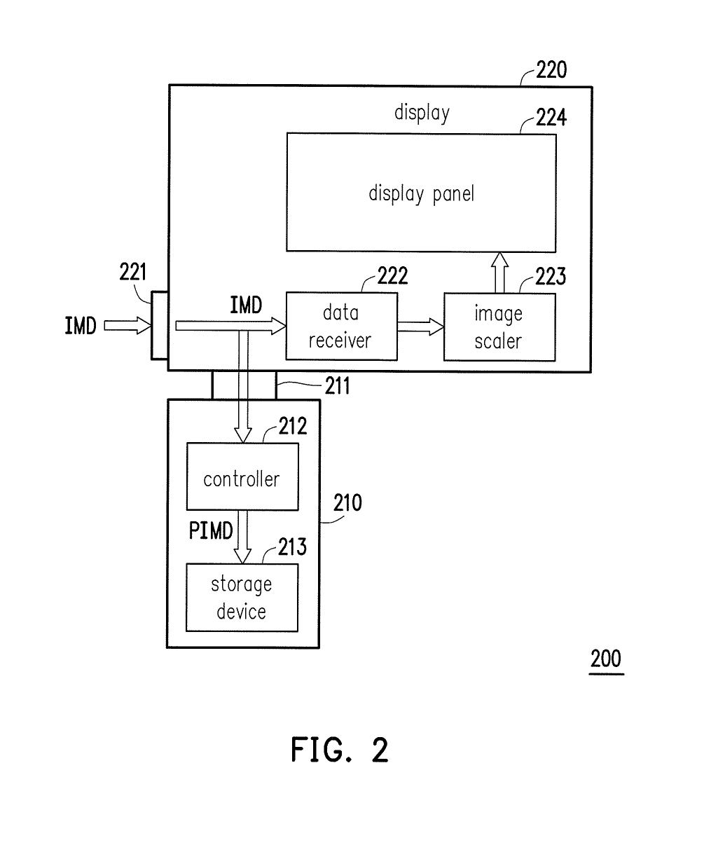

Please refer to FIG. 2. FIG. 2 is a schematic diagram showing an image display system in an embodiment. The image display system 200 includes an image data capture device 210 and a display 220. The image data capture device 210 includes a connector 211, a controller 212, and a storage device 230. The display 220 includes a data source connector 221, a data receiver 222, an image scaler 223, and a display panel 224. The data source connector 221 receives the image data IMD, and transfers the image data IMD to the data receiver 222. The data receiver 222 is also coupled with the image scaler 223. The data receiver 222 transfers the image data IMD to the image scaler 223, and the image scaler 223 scales the image data IMD according to the image revolution of the display panel 224, and the scaled image data is transferred to the display panel, and the image corresponding to the image data is displayed.

The image data capture device 210 is connected between the data source connector 221 and the data receiver 222. Then, the image data capture device 210 receives the original image data IMD directly which is unsealed. The original image data IMD is captured and stored in the storage device 213 after the original image data IMD is encoded by the controller 212.

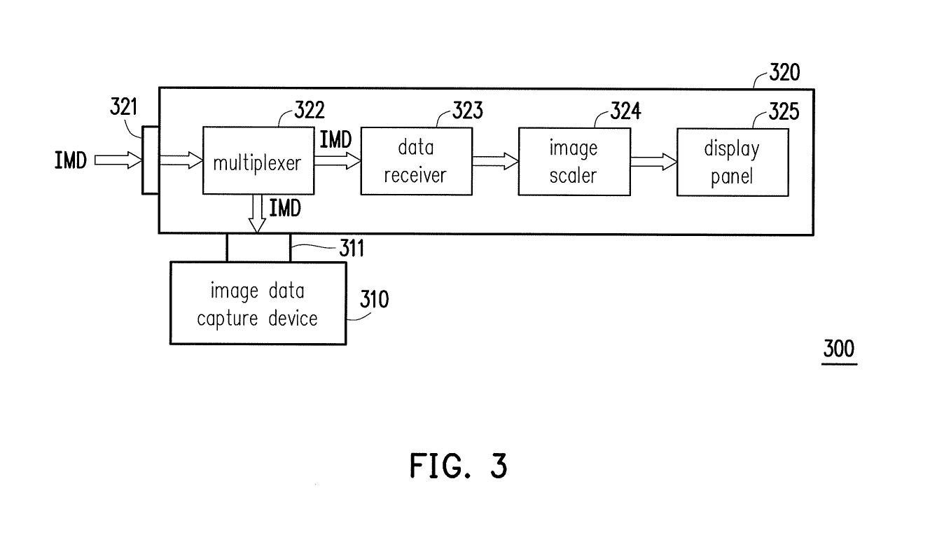

Please refer to FIG. 3. FIG. 3 is a schematic diagram showing an image display system in an embodiment. The image display system 300 includes an image data capture device 310 and a display 320. The display 320 includes a data source connector 321, a multiplexer 322, a data receiver 323, an image scaler 324, and a display panel 325. In the embodiment, the image data capture device 310 is connected with the multiplexer 322. The multiplexer 322 receives the image data and transfers the image data IMD to the image data capture device 310 and the data receiver 323.

In this embodiment, with the configuration of the multiplexer 322, the display 320 simultaneously transfers the image data IMD to the image data capture device 310 and the data receiver 323. Furthermore, the image data IMD is provided to the image data capture device 310 in real time without affecting the fluency of images displayed at the display panel 325, and then the image data capture device 310 is captured while the display 320 displays smoothly.

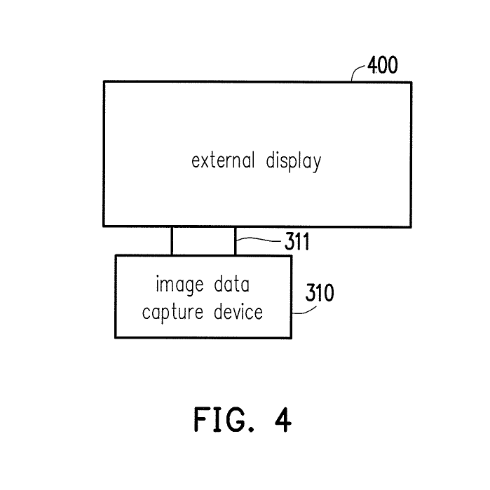

Please refer to FIG. 4. FIG. 4 is a schematic diagram showing an enforcement mode of the image data capture. In FIG. 4, after the image data capture device 310 captures the image data one time or several times, the captured image data can be shared by connecting the image data capture device 310 to an external display 400. Therefore, the convenience of sharing the image data is significantly improved.

In sum, the image data capture device is connected with a display to capture the original image data which is unsealed. As a result, the image data capture device obtains the image data with the highest quality for display.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An image data capture device, comprising:
a connector connected to an image data transfer path of a display and receiving image data transferred on the image data transfer path;
a controller coupled with the connector, encoding and decoding the image data to generate a processed image data; and
a storage device coupled with the controller, for storing the processed image data.

2. The image data capture device according to claim 1, wherein the image data is unsealed image data.

3. The image data capture device according to claim 1, wherein the image data foil la includes High-Bandwidth Digital Content Protection (HDCP).

4. The image data capture device according to claim 1, wherein the image data capture device is further connected to an external display via the connector, the image data capture device decodes the processed image data stored in the storage device to generate a decoded image data and provides the decoded image data to the external display, the external display displays images according to the processed image data.

5. The image data capture device according to claim 4, wherein the image data capture device provides the decoded image data in 720p or 1080p display format to the external display.

6. An image display system, comprising:
a display having a data source connector, for receiving image data; and
an image data capture device, including:
a connector connected to the data source connector and receiving the image data;
a controller coupled with the connector, encoding and decoding the image data to generate a processed image data; and
a storage device coupled with the controller and storing the processed image data.

7. The image display system according to claim 6, wherein the display further comprises:
a data receiver coupled with the data source connector, for receiving the image data;
an image scaler coupled with the data receiver and scaling the image data to generate scaled image data; and
a display panel coupled with the image scaler, receiving the scaled image data and displaying images according to the scaled image data.

8. The image display system according to claim 6, wherein the display further comprises:
a multiplexer connected between the data receiver and the data source connector,
wherein when the connector of the image data capture device is connected with the data source connector, the multiplexer transfers the image data to the data receiver and the connector.

9. The image display system according to claim 6, wherein the image data capture device is further connected to an external display via the connector, the image data capture device provides the processed image data stored in the storage device to the external display for display.

10. The image display system according to claim 6, wherein the image data format includes High-Bandwidth Digital Content Protection (HDCP).
